(19) United States
(12) Patent Application Publication
(10) Pub. No.: US 2002/0054729 A1
(43) Pub. Date: May 9, 2002

(54) Piezoelectric optical switch

(76) Inventors: John S. Berg, Bellingham, MA (US); Mark Steinback, Newton, MA (US); Patrick Tan, Wellesley, MA (US); David Kindler, Concord, MA (US); Raymond Pavlak, Shrewsbury, MA (US); John Ritter, Wayland, MA (US); Hae-Kwon Chung, Boston, MA (US); David Kent, Framingham, MA (US); Phillip H. Malyak, Canton, MA (US)

Correspondence Address: FAUSTINO A. LICHAUCO, Fish & Richardson P.C., 225 Franklin Street, Boston, MA, 02110-2804, US

(21) Appl. No.: 09/791,398

(22) Filed: Feb. 23, 2001

Related U.S. Application Data
(60) Provisional application No. 60/245,659, filed on Nov. 3, 2000.

(51) Int. Cl. G02B 6/35

(52) U.S. Cl. 385/18; 385/16

(57) ABSTRACT

An actuator for controlling a pitch angle and a yaw angle of a mirror in a fiber-optic switch includes a piezoelectric strip having a first and second arm. The first arm extends from a substrate in a first direction. The second arm, which is for attachment to the mirror, extends from the first arm in a second direction different from the first direction. A pitch-electrode, in electrical communication with the first arm, controls pitch angle by causing deflection of the first arm. A yaw-electrode, in electrical communication with the second arm, controls the yaw angle by deflecting the second arm.

### FIELD OF INVENTION

This invention relates to fiber-optic networks, and in particular, to switches for directing signals from one optical fiber to another. BACKGROUND

When two parties communicate over a telephone network, a single physical communication path is set up between their two telephones. Given the vast number of telephones, it is impractical to actually wire each telephone to all other telephones on the telephone network. Instead, the telephones are connected to switches. These switches cooperate to establish and tear down physical paths between telephones on an as-needed basis.

In the early days of telephony, the “switch” was a human operator who sat in front of a switchboard making connections between pairs of receptacles, each receptacle corresponding to a telephone line. Because the telephone signals were electrical signals traveling on copper wire, the operator would connect the two receptacles with a length of copper wire, just like the copper wire on which the telephone signals traveled. Eventually, the operator gave way to automated electromechanical, and later to all electronic switching devices. The connection between the two telephone lines, however, remained electrical. This was reasonable because the telephone signals themselves continued to travel as electrical signals on copper wire.

The end of the last century saw the advent of telephone signals propagating as beams of light on optical fibers rather then as electrical signals on copper wires. Nevertheless, the switches that connected optical fibers together remained electrical. As a result, an optical signal propagating on the optical fiber would have to be converted to an electrical signal, switched, and then converted back to an optical signal.

The need to convert between optical signals and electrical signals is a significant bottleneck in a network having fiber-optic communication paths. A conventional fiber-optic cable can easily carry 15,000 Gbps. The currently practical limit of 40 Gbps is primarily the result of a limit at which currently available optoelectronic devices can switch between optical and electrical signals. It is therefore desirable to replace optoelectronic switches with all-optical switches.

### SUMMARY

The invention provides a mirror element for use in an all-optical switch to reflect light from an output end of a first fiber-optic cable to an input end of a second fiber-optic cable. The mirror element includes a mirror whose pitch and yaw angle can be controlled, thereby enabling the mirror to reflect light along a path in the direction of the second fiber-optic cable. This feature of the invention enables it to selectively direct light to any fiber-optic cable in a two-dimensional array of fiber-optic cables, such as that typically used in a fiber-optic switch.

In one embodiment, a mirror is attached to a piezoelectric actuator that is deflectable with two degrees of freedom in response to a control signal. Because the mirror is attached to the piezoelectric actuator, deflection of the actuator causes movement of the mirror. Because the actuator is deflectable with two degrees of freedom, it can control both the pitch angle and the yaw angle of the mirror.

The piezoelectric actuator includes a first deflecting element that deflects along a first direction and a second deflecting element that deflects along a second direction. The two deflecting elements of the piezoelectric actuator deflect in response to voltages applied to a first electrode, in electrical communication with the first deflecting element, and a second electrode, in electrical communication with the second deflecting element. Deflection along the first direction controls primarily the pitch angle of the mirror; deflection along the second direction controls primarily the yaw angle of the mirror.

In one embodiment, the first and second deflecting elements of the piezoelectric actuator are first and second arms that extend in different directions. The different directions can, but need not be, perpendicular to each other. The second arm can extend from any point on the first arm. However, in one practice of the invention, the second arm extends from a distal end of the first arm. In either case, the point at which the first and second arms intersect can be coupled to a stiffening element.

In this embodiment of the invention, the first and second arms can be deflected by applying control voltages to a pitch electrode in communication with the first arm and to a yaw electrode in communication with the second arm. A voltage applied to the pitch electrode causes the first arm to deflect along the first direction. Conversely, a voltage applied to the yaw electrode causes the second arm to deflect along the second direction. To apply the requisite voltages to the pitch and yaw electrodes, the invention optionally includes a controller in communication with the pitch-electrode and the yaw-electrode.

The piezoelectric strip can be a two-layer structure in which a first layer of piezoelectric material and a second layer of piezoelectric material meet at an interface. The piezoelectric strip is typically made of a piezoelectric material that can be deposited on the substrate by thin-film deposition. An example of a suitable piezoelectric material is zinc oxide.

An electrode common to other piezoelectric actuators in a mirror array can be disposed on a first surface of the piezoelectric strip. In addition, a second common electrode, which is also common to other piezoelectric actuators in the mirror array, can be disposed on a second surface of the piezoelectric strip.

In one embodiment of the invention, the actuator includes both a first common electrode in electrical communication with the first layer and a second common electrode in electrical communication with the second layer. The first common-electrode can be disposed on the first layer opposite the pitch electrode and the second common-electrode can be disposed on the second layer opposite the pitch electrode. In this configuration, the pitch electrode is sandwiched by the two common electrodes and separated therefrom by layers of piezoelectric material.

The invention also includes a method for controlling pitch and yaw angle of a mirror in a fiber-optic switch. Such a method includes the application of a selected pitch-control signal to a pitch-electrode in electrical communication with a first arm of a piezoelectric bimorph strip, and the application of a selected yaw-control signal to a yaw-electrode in electrical communication with a second arm of the piezoelectric bimorph strip. The first and second arms define two different directions. Hence, deflection of the first and second arms by suitable pitch and yaw control signals enables control of both the pitch and yaw angles of the mirror. The method of the invention optionally includes determining the pitch-control signal and the yaw-control signal on the basis of a desired pitch angle and a desired yaw angle.

In another aspect of the invention, a mirror element for a fiber-optic switch includes a mirror attached to a piezoelectric actuator that is deflectable with two degrees of freedom. An electrical connection to the piezoelectric actuator provides access to a control voltage that selectively deflects the piezoelectric actuator to control pitch and yaw angles of the mirror. The piezoelectric actuator can be a bimorph having a first layer and a second layer meeting at an interface.

The piezoelectric actuator can include a first deflecting element that deflects along a first direction. This first deflecting element controls primarily the pitch angle of the mirror. The piezoelectric actuator can then include a second deflecting element that deflects along a second direction. This second deflecting element controls primarily the yaw angle. The first direction, defined by the first deflecting element, typically differs from the second direction defined by the second deflecting element.

The mirror itself can be attached to either one of the first and second deflecting elements. In one embodiment, the piezoelectric actuator is a piezoelectric strip having a proximal end and a distal end. The mirror can be attached to any point on the piezoelectric strip. However, in another embodiment, the mirror is attached to the distal end of the piezoelectric strip.

Where the mirror is to be attached to the distal end of the piezoelectric strip, a first arm extends from the proximal end of the piezoelectric strip and a second arm, for attachment to the mirror, extends between the first arm and the distal end of the piezoelectric strip. The first and second arms define two different directions.

In another embodiment of the invention, the first arm extends from the proximal end of the piezoelectric strip to an elbow and the second arm extends from the elbow to the distal end of the piezoelectric strip. The elbow can be reinforced by coupling it to an optional stiffening element. In either case, the directions defined by the first and second arms can be, but need not be, perpendicular.

The electrical connection to the mirror element can include a pitch-electrode and a yaw electrode. The pitch electrode is in electrical communication with the piezoelectric actuator for deflecting the actuator to control a pitch angle of the mirror. Similarly, the yaw-electrode is in electrical communication with the actuator for deflecting the actuator to control a yaw angle of the mirror. The invention can also encompass a controller in communication with the electrical connection for providing the control voltages to the pitch-electrode and to the yaw electrodes.

The invention also encompasses a fiber-optic switch for directing a beam emerging from an input optical fiber to a selected output optical fiber. Such a fiber-optic switch includes a first array of mirror elements, each of the which has a moveable mirror having a variable pitch angle and a variable yaw angle. A piezoelectric strip coupled to the moveable mirror has a first arm extending in a first direction and a second arm, which is coupled to the mirror, extending in a second direction different from the first direction. A pitch-electrode in electrical communication with the first arm deflects the first arm and thereby provides control over the mirror's pitch angle. Similarly, a yaw-electrode in electrical communication with the second arm deflects the second arm and thereby provides control over the mirror's yaw angle.

The fiber-optic switch optionally includes a second array of mirror elements like the first mirror array. The mirror elements of the second mirror array, like those of the first mirror array, each have a moveable mirror having a variable pitch angle and a variable yaw angle. A piezoelectric strip coupled to the moveable mirror has a first arm extending in a first direction and a second arm, which is coupled to the mirror, extending in a second direction different from the first direction. A pitch-electrode in electrical communication with the first arm deflects the first arm and thereby provides control over the mirror's pitch angle. Similarly, a yaw-electrode in electrical communication with the second arm deflects the second arm and thereby provides control over the mirror's yaw angle.

In one embodiment, the fiber-optic switch also includes a controller in communication with the pitch-electrode and the yaw-electrode. The controller is adapted to apply a pitch voltage to the pitch-electrode and a yaw voltage to the yaw-electrode. An optional position sensor in communication with the controller provides an error signal indicative of an error in the pitch angle and the yaw angle. In an embodiment that includes the optional position sensor, the controller can adjust the pitch voltage and the yaw voltage in response to the error signal generated by the position sensor.

The position sensor can include several photosensors arranged in an annulus having a central axis orthogonal to a plane defined by the annulus. For most purposes, a position sensor having four photosensors has been found to be adequate. The annulus is disposed so that in the absence of error in the pitch angle and the yaw angle, a central axis of the beam is coincident with the central axis of the annulus. As a result, to the extent that the beam is radially symmetric, all the photosensors that make up the annulus receive the essentially the same photon flux.

Another aspect of the invention is a control system for controlling an orientation of a mirror in a fiber-optic switch. Such a control system includes a position sensor disposed to intercept a beam reflected from the mirror. The position provides a controller with an error signal indicative of a deviation of the orientation from a desired orientation. In response to the error signals, the controller generates control signals for correcting the orientation of the mirror. These control signals are provided to a mirror-actuator coupled to the mirror. The mirror-actuator then alters the orientation of the mirror in response to the control signals.

In one embodiment of the control system, the position sensor includes several photosensors arranged in an annulus having a central axis orthogonal to a plane defined by the annulus. For most purposes, a position sensor with four photosensors has been found adequate. In a position sensor with four photosensors, it is enough that each photosensor subtend an angle of less than ten degrees of arc.

The annulus is disposed so that in the absence of error in the orientation of the mirror, a central axis of the beam is coincident with the central axis of the annulus. In one embodiment of the control system, the photosensors that form the annulus are disposed on a lens.

In another embodiment of the invention, a mirror array includes a substrate and a plurality of piezoelectric actuators supported by the substrate. Each piezoelectric actuator couples to a mirror from a plurality of mirrors. In response to a drive signal, each piezoelectric actuator causes relative motion between the mirror with which it is coupled and the substrate.

A mirror array according to the invention can be made very small and densely packed with mirrors. In one embodiment of a mirror array, each mirror is less than six-hundred microns in diameter. In another embodiment, a first center of a first mirror from the plurality of mirrors and a second center of a second mirror selected from the plurality of mirrors are separated from each other by less than two millimeters. In another embodiment, the plurality of mirrors comprises at least five-hundred mirrors. In yet another embodiment, each of five-hundred mirrors is less than six-hundred microns in diameter, and centers of adjacent mirrors lie as close as two millimeters from each other.

In one embodiment of the mirror array, each piezoelectric actuator includes a first electrode disposed between first and second layers of piezoelectric material. In this embodiment, second and third electrodes can be disposed on a top surface of the first layer and on a bottom surface of the second layer, respectively.

In another embodiment of the mirror array, each piezoelectric actuator includes a first arm extending in a first direction and a second arm extending in a second direction different from the first direction. In this embodiment, the second arm couples to a corresponding mirror from the plurality of mirrors.

The invention also includes a fiber-optic switch having an input face positioned to receive a plurality of input optical fibers and a first mirror array positioned to selectively redirect a light beam emerging from an input optical fiber from the plurality of input optical fibers, a second mirror array positioned to selectively redirect the light beam redirected by the first mirror array; and an output face positioned to couple, to an output optical fiber from a plurality of output optical fibers, the light beam redirected by the second mirror array. Each of then the first and second mirror arrays includes a plurality of piezoelectric actuators, and a plurality of mirrors each coupled to a corresponding piezoelectric actuator from the plurality of piezoelectric actuators.

The invention also encompasses a method for fabricating a fiber-optic mirror array that includes a substrate, a plurality of piezoelectric actuators supported by the substrate, and a plurality of mirrors each coupled to a different one of the plurality of piezoelectric actuators to provide relative motion between each mirror and the substrate in response to a piezoelectric drive signal to the corresponding piezoelectric actuator. Such a method includes the formation of a patterned release layer over the substrate to define a plurality of target areas, the formation of a patterned mirror layer over the release layer; the formation of at least one patterned layer of piezoelectric material over the substrate to separately cover at least a portion of the release layer at each target area, and the removal of the release layer to cause the patterned mirror layer to define the plurality of mirrors and cause the at least one patterned layer of piezoelectric material to define the plurality of piezoelectric actuators.

In one practice of the foregoing method, formation of at least one patterned layer of piezoelectric material includes the formation of two patterned layers of piezoelectric material and of an electrode layer between the two patterned layers of piezoelectric material.

In another practice of the foregoing method, removal of the release layer includes exposure of the release layer by ion etching the underside of the substrate to expose the release layer, followed by the wet etching the exposed release layer.

The method of the invention can also include formation of at least one patterned electrode layer over the substrate to separately cover at least a portion of the release layer at each target area. This can include the formation of an electrode layer having three layers, two of which are chromium layers and the third of which is a gold layer sandwiched between the two chromium layers.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the present specification, including definitions, will control. In addition, the materials, methods, and examples are illustrative only and not intended to be limiting.

These and other features and advantages of the invention will be apparent from the following detailed description, the claims, and the accompanying figures, in which:

### BRIEF DESCRIPTION OF THE FIGURES

FIG. 1 is an isometric view of a fiber-optic switch;

FIG. 2 is a cross-section of the fiber-optic switch of FIG. 1 showing two mirror arrays;

FIG. 3 shows a position sensor adjacent to one of the two mirror arrays in FIG. 2;

FIG. 4 is a planar view of a section of one of the mirror arrays shown in FIG. 2;

FIG. 5 is a planar view of a mirror element from the mirror array shown in FIG. 4 showing first and second arms of a piezoelectric actuator;

FIG. 6 is a cross-section of the mirror element of FIG. 5 showing a longitudinal cross-section of the first arm and a transverse cross-section of the second arm;

FIG. 7 is the cross-section of the mirror element of FIG. 5 but unfolded so as to show longitudinal cross-sections of both the first and second arms of the actuator; and

FIGS. 8-21 show a cross-section of the mirror element of FIG. 5 at various stages in its fabrication.

### DETAILED DESCRIPTION

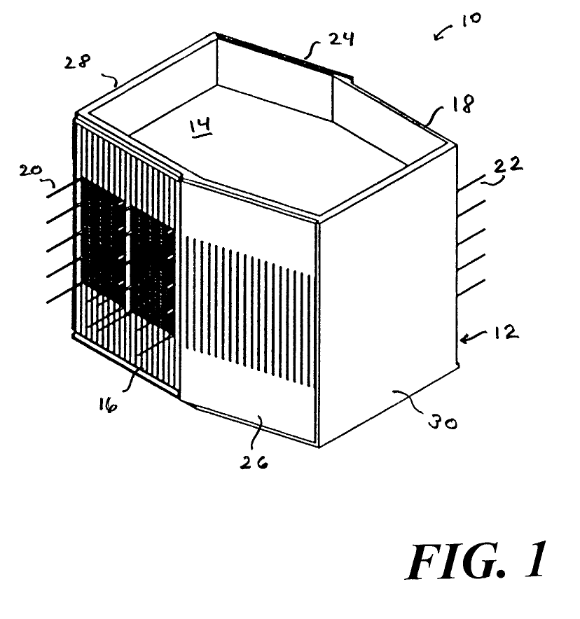

FIG. 1 shows an optical switch 10 in which a piezo-electrically activated-mirror according to the invention is deployed. The switch 10 includes a hexagonal junction box 12 that defines a chamber 14 through which light beams carrying signals can propagate. The junction box 12 has an input face 16 and an output face 18 parallel to the input face 16 for coupling to arrays of input and output optical fibers respectively.

In FIG. 1, a representative input optical fiber 20 is shown coupled to the input face 16 and a representative output optical fiber 22 is shown coupled to the output face 18. The number of input and output optical fibers depends on the area of the input and output faces 16, 18. However, it is desirable to have as many optical fibers as possible. At present, the distance between centers of adjacent optical fibers (“pitch”) on the input and output faces 16, 18 can be made as small as 1 mm. With this pitch, a typical optical switch 10 can accommodate an array of approximately 1000 optical fibers.

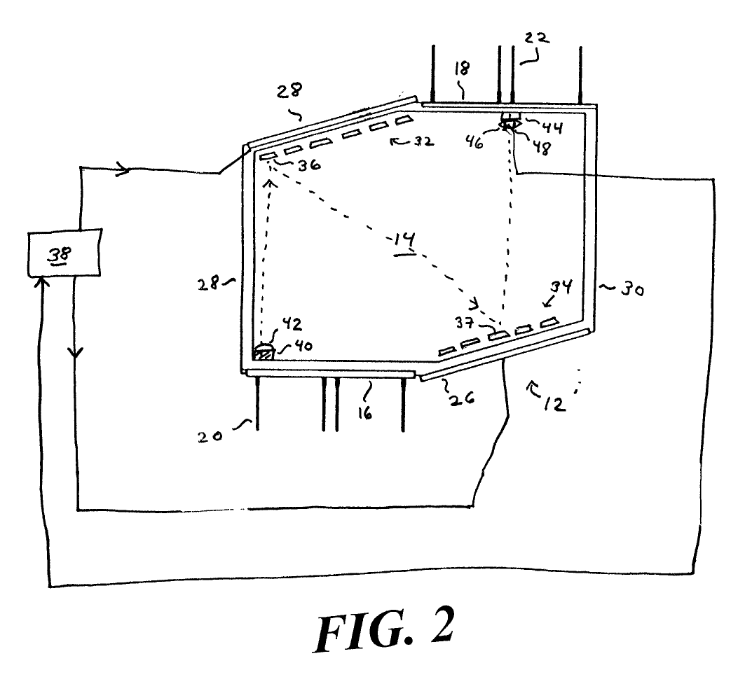

The remaining four faces of the junction box 12 include parallel first and second coupling faces 24, 26 opposed to the input and output faces 16, 18 respectively, and parallel first and second side faces 28, 30 extending between the first and second coupling faces 24, 26 and the input and output faces 16, 18. As shown in the top view of FIG. 2, the first coupling face 24 is angled relative to and separated from the input face 16 such that a light beam normal to the input face 16 will reflect off the first coupling face 24 in the direction of the second coupling face 26. The second coupling face 26 is angled relative to and separated from the output face 18 such that light incident on the second coupling face 26 from the first coupling face 24 will be reflected in a direction toward and normal to the output face 18.

In the illustrated embodiment, the angle between the input face 16 and the first coupling face 24 is approximately 18 degrees. Similarly, the angle between the second coupling face 26 and the output face 18 is approximately 18 degrees. The first and second side faces 28, 30 are approximately 49 mm long, the input and output faces 16, 18 are approximately 34 mm long, and the coupling faces 24, 26 are approximately 36 mm long. The height of the junction box 12, and hence all six of the above-mentioned faces, is approximately 35 mm.

A first mirror array 32 is disposed on the first coupling face 24 in the interior of the chamber 14. Similarly, a second mirror array 34 is disposed on the second coupling face 26 in the interior of the chamber 14. The first and second mirror arrays 32, 34 each include a rectangular array of very small (on the order of 500 μm) moveable mirrors. A controller 38 in communication with the first and second mirror arrays 32, 34 controls the pitch and yaw angles of each of the moveable mirrors.

Each input optical fiber 20 is mechanically coupled to the input face 16 by an input coupler 40. An input lens 42 adjacent to the input coupler 40 on the inside of the junction box 12 is disposed in the path of a beam carried by the input optical fiber 20. Similarly, each output optical fiber 22 terminates in an output coupler 44 having an output lens 46 disposed in the path of a beam entering the output coupler 44. The output coupler 44 also includes a position sensor 48 that generates a feedback signal indicative of how far an incident beam is from the center of the output lens 46. This feedback signal is provided to the controller 38, which uses it to make adjustments to the positions of the appropriate mirrors from one or both of the first and second mirror arrays 32, 34.

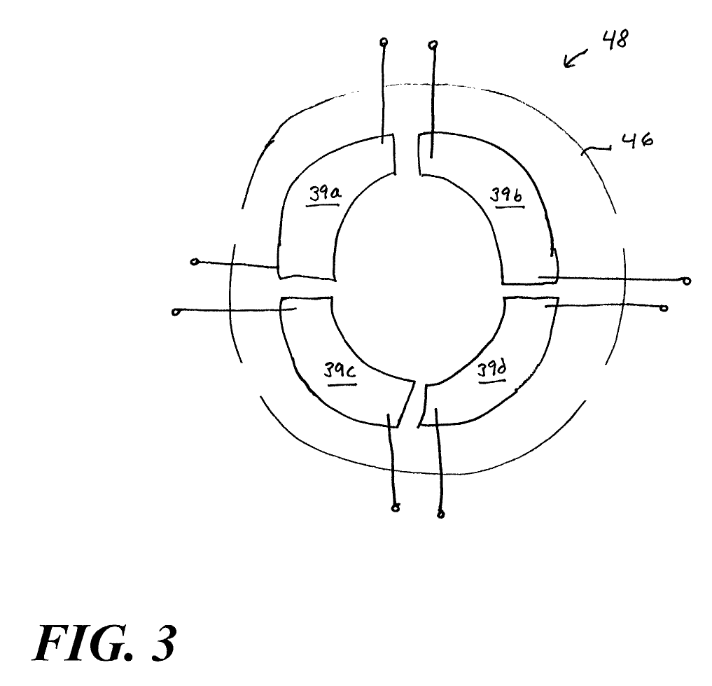

The position sensor 48, shown in more detail in FIG. 3, is an annulus along which four photosensors 39a-d are attached to the output lens. Each photosensor 39a occupies up to ninety degrees of arc along the circumference of the annulus. The inner diameter of the annulus is selected to be slightly smaller than the diameter of the beam.

Each of the photosensors 39a has an output that depends on the photon flux integrated over the surface of that photosensor 39a. These outputs are connected to the controller 38 for use in adjusting the pitch and yaw of the appropriate moveable mirrors on the first and second mirror arrays 32, 34.

In operation, the central portion of the beam passes through the hole in the annulus formed by the photosensors 39a-d. Because the inner diameter of the annulus is slightly smaller than the beam diameter, the peripheral portion of the beam falls on the four photosensors 39a-d. To the extent that the center of the beam coincides with the center of the annulus, the photon flux on the four photosensors 39a-d will be equal and the outputs generated by the four photosensors 39a-d will be equal.

A beam that deviates from correct alignment will result in one or more photosensors 39a-d capturing photons that would normally pass through the center of the annulus. The identity of the photosensors 39a-d capturing this increased photon flux provides the controller 38 with information from which the direction of deviation can be calculated. The extent of the disparity in the outputs of the photosensors 39a-d provides the controller 38 with information on the extent of the deviation. The controller 38 uses this information to adjust the pitch and yaw angles of the appropriate moveable mirrors so as to move the center of the beam to the center of the annulus.

The value of the inner diameter results from a compromise between the signal strengths available to the controller 38 and to the output optical fiber 22. A small inner diameter enhances the signal-to-noise ratio available to the controller 38 but at the cost of signal-to-noise ratio of the signal being carried by the beam. The outer diameter is selected to capture sufficient photon flux from the peripheral portion of the beam to generate a signal usable by the controller 38.

As shown, the position sensor includes four photosensors each of which encompasses approximately ninety degrees of arc. However, the photosensors can also occupy less than ninety degrees of arc. For example, a suitable position sensor can be made by placing photosensors that encompass as little as ten degrees of arc along the annulus. A position sensor can also be made by providing more or fewer than four photosensors. In operation, a beam to be switched from the input optical fiber 20 to the output optical fiber 22 enters the input coupler 40 and passes through the input lens 42. The beam, now collimated by the input lens 42, travels through the chamber 14 and reaches a first mirror 36 corresponding to that input optical fiber 20. The first mirror 36 reflects the beam across the chamber 14 toward a second mirror 37 associated with the output optical fiber 22. This second mirror 37 reflects the beam to the output lens 46, which then sends the beam into the output coupler 44. The output coupler 44 then couples the beam into the output optical fiber 22. By appropriately controlling the pitch and yaw angles of the first and second mirrors 36, 37, the controller 38 can direct a beam from the input optical fiber 20 to any output optical fiber.

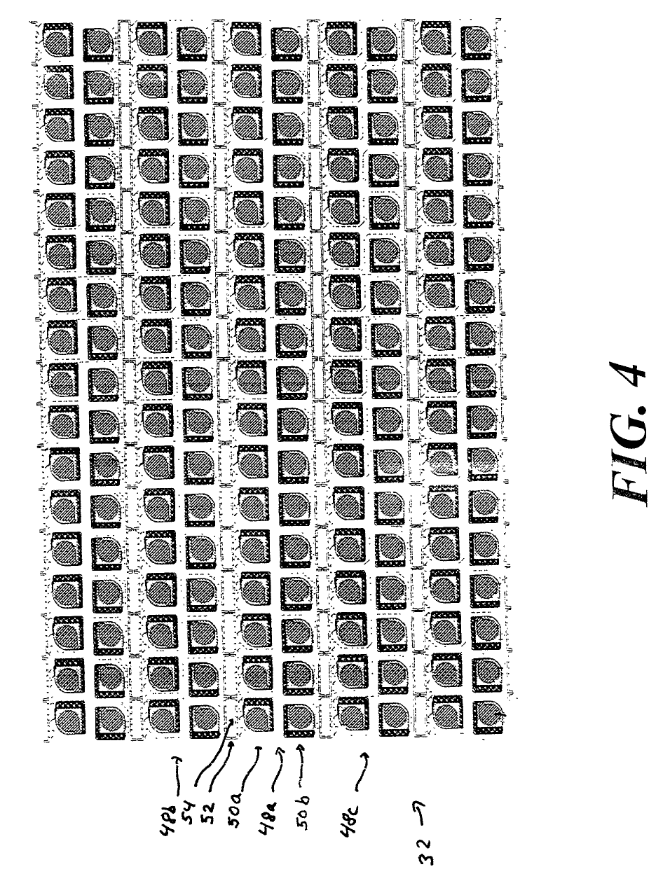

FIG. 4 is a close-up view of a portion of the input mirror array 32. The input mirror array 32 includes a mirror strip 48a with two rows 50a-b of mirror elements. Each mirror strip 48a is epoxied onto a backing (not shown). The backing is typically made of the same material as the mirror strip 48a to avoid the deformations that arise in coupling two structures having different thermal expansion coefficients.

A slot 54 between adjacent mirror strips 48a, 48b provides access for a flexible strip (not shown) on which are imprinted conducting paths leading to the controller 38. These conducting paths are gold-ball-bonded to the corresponding electrical contacts on each mirror element.

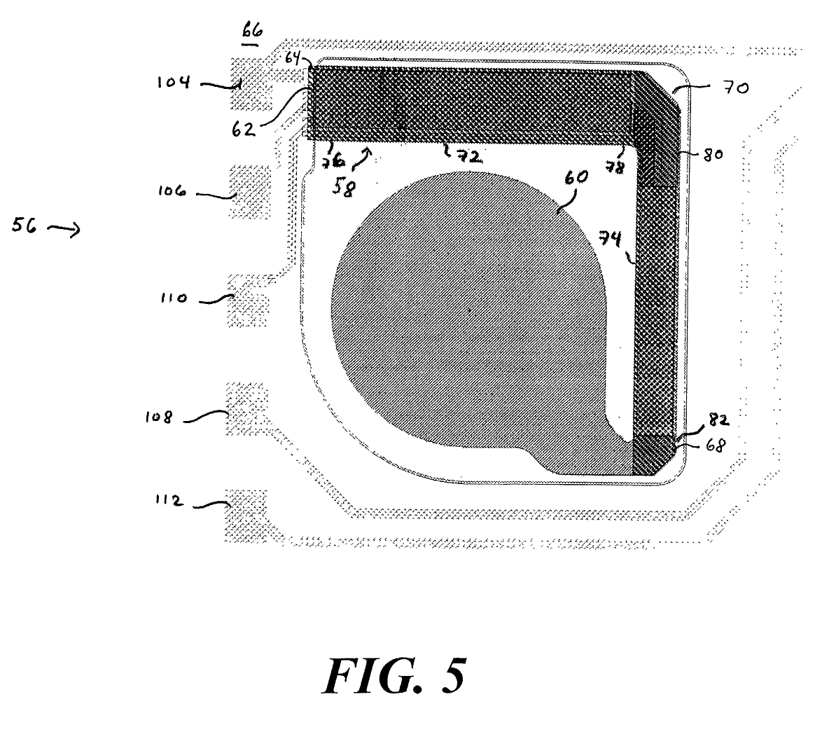

FIG. 5 shows a more detailed view of a mirror element 56 from the mirror array 32 in FIG. 4. The mirror element 56 includes a piezoelectric actuator 58 for controlling the pitch and yaw angles of a mirror 60. The actuator 58 includes a piezoelectric bimorph strip 62 having a proximal end 64 attached to a substrate 66 and a distal end 68 attached to the mirror 60. The bimorph strip 62 is bent at an elbow 70 to form a first arm 72 and a second arm 74 perpendicular to the first arm 72. The first arm 72 has a proximal end 76 coincident with the proximal end of the bimorph strip 62 and a distal end 78 at the elbow 70. The second arm 74, which is integral with the first arm 72, has a proximal end 80 at the elbow 70 and a distal end 82 to which the mirror 60 is attached.

The bimorph strip includes two adjacent layers of a piezoelectric material. Such a structure is advantageous because the two adjacent layers will have the same thermal expansion coefficient. As a result, the bimorph strip is protected against temperature induced deformation caused by the intimate coupling of two materials having different thermal expansion coefficients.

The substrate on which the mirror elements 56 is formed is typically a single-crystal silicon substrate. However, other materials such as fused quartz or ceramic are suitable for use as a substrate. The mirror 60 is typically a composite of deposited materials. In one embodiment, the mirror 60 has a gold surface deposited over a mirror body.

The mirror 60 can be a flat mirror or a mirror having a curved surface for focusing. In one embodiment, the mirror 60 is anisotropically stressed to stiffen it against bending. One method of anisotropically stressing the mirror 60 is to provide circumferential corrugations at the edge of the mirror 60.

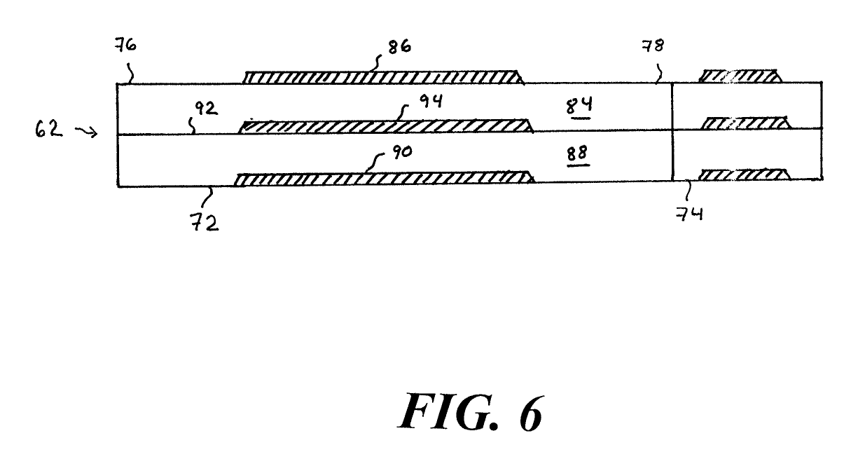

The bimorph strip 62, shown in cross-section in FIG. 6, includes a first layer 84 made of a first piezoelectric material in contact with a first common-electrode 86 and a second layer 88 made of a second piezoelectric material in contact with a second common-electrode 90. The first and second layers 84, 88 meet at an interface 92 at which is placed a pitch electrode 94. The first and second piezoelectric materials can be different materials or the same material. The piezoelectric material is selected to have low conductivity, thereby reducing the power consumed in operating the actuator 58. Because of its amenability to thin-film processing techniques, a suitable piezoelectric material for use in the first and second layer 84, 88 is zinc-oxide. However, other piezoelectric materials, such as PZT (lead zirconium titanate) also have suitable physical properties for use in the actuator 58.

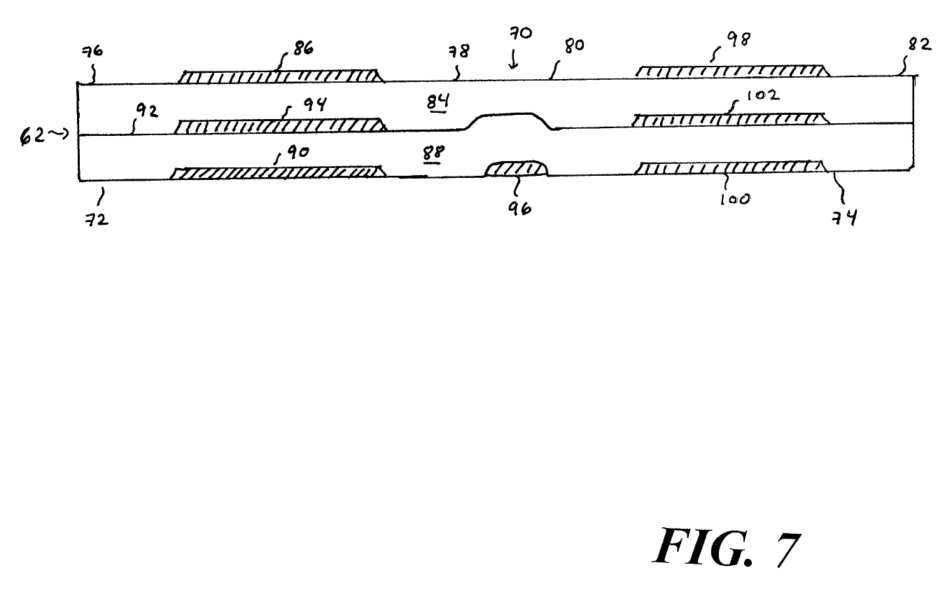

FIG. 7 shows the cross-section of FIG. 6 but unfolded so that the cross-section of the second arm 74 is also visible. As shown in FIG. 7, the first and second piezoelectric layers 84, 88 extend continuously from the first arm 72 into the second arm 74. The elbow 70 can include an optional stiffening element 96 to reduce coupling between the pitching and yawing motion of the mirror 60 and to suppress undesired oscillation of the second arm 74.

The second arm 74 includes a third common-electrode 98 in contact with the first piezoelectric layer 84, a fourth common-electrode 100 in contact with the second piezoelectric layer 88, and a yaw electrode 102 at the interface 92 between the first and second piezoelectric layers 84, 88. The four common electrodes 86, 90, 98, 100 are all maintained at the same voltage.

Each pair of first and second mirror elements shown in FIG. 4 includes electrical contacts for connection to the controller 38. These electrical contacts, best seen in FIG. 5, include: a common terminal 104 leading to the common electrodes 86, 90, 98, 100, of both first and second mirror elements in the pair of mirror elements; first and second pitch-control terminals 106, 108 leading to the pitch-electrodes 94 of the first and second mirror elements respectively; and first and second yaw-control terminals 110, 112 leading to the two yaw-electrodes 102 of the first and second mirror elements respectively.

The layers of piezoelectric materials and the electrodes are typically fabricated by thin-film deposition techniques. Such techniques include physical deposition techniques, such as sputtering, evaporation, and CVD (chemical vapor decomposition), and chemical deposition techniques, such as plating. Between the various steps, any organic contaminants are removed by exposing the strucutre to an oxygen plasma, a processs referred to in the art as “descumming”. The masks that allow sputtered material to contact selected portions of the structure are deposited or removed by lithographic techniques. The use of thin-film deposition techniques, combined with lithography, enables the fabrication of well-aligned arrays of small, virtually identical mirror elements, as illustrated, by example, in the following procedure.

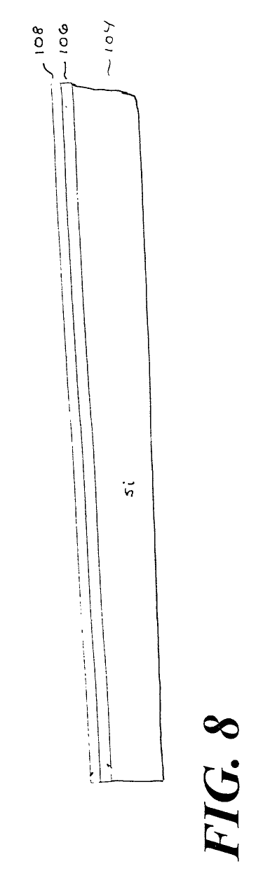

The mirror element 56 is fabricated on a silicon substrate 104 having a face on which a stop layer 106, such as silicon dioxide or silicon nitride has been deposited, as shown in FIG. 8. The stop layer 106 is intended to stop deep-reactive-ion-etching later in the fabrication process. A thickness of approximately 1500-3000 Angstroms has been found to be suitable for this purpose. Substrates as described above are commercially available from a variety of manufacturers.

The first step in fabrication of the mirror element 56 is the formation of a release layer 108 on top the stop layer 106, as shown in FIG. 8. This is done by sputtering a 1000-7000 Angstrom thick layer of molybdenum onto the stop layer 106. The purpose of the release layer 108 is to act as a temporary scaffolding to support the mirror 60 and the actuator 58 during fabrication. The release layer 108 will be removed near the end of the fabrication process, leaving behind a cavity over which the mirror 60 and the actuator 58 are suspended.

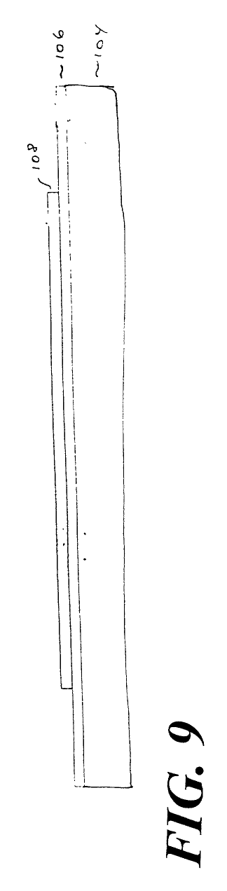

The next step is thus to remove those portions of the release layer 108 that will not be located under the region bounded by the mirror 60 and the actuator 58. This is performed by coating the release layer 108 with a photoresistive layer and masking those portions of the release layer 108 that will underlie the region bounded by the mirror 60 and the actuator 58. The exposed portion of the release layer 108 is then wet-etched using 15% hydrogen peroxide at room temperature. After wet-etching and removal of the mask, the remaining release layer 108 is as shown in FIG. 9.

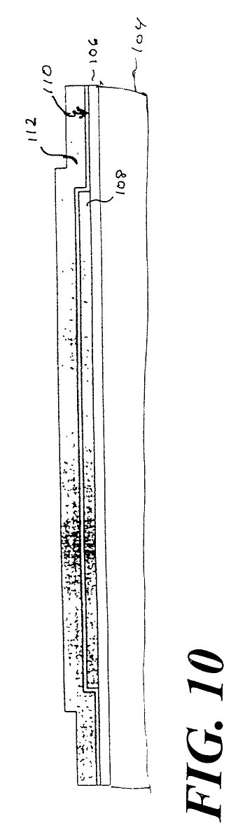

The next step in the fabrication of the mirror element 56 is the deposition, by sputtering, of a base electrode-layer 110 which will later be selectively etched to form the second and fourth common electrodes 90, 100 and the leads that connect the mirror elements 56 to the controller 38. This base electrode-layer 110 consists of a 2000 Angstrom gold layer sandwiched between a pair of 200 Angstrom chromium layers. The two outer chromium layers are desirable because chromium atoms adhere well to neighboring atoms, whereas gold atoms do not. The chromium and gold layers are formed by sputtering chromium and gold atoms respectively. This results in the stepped base electrode-layer 110 shown in FIG. 10.

Following the formation of the base electrode-layer 110, the next step is the deposition of a body layer 112, shown in FIG. 10, that will ultimately become the body of the mirror 60 and the elbow 70. The body layer 112 is formed by sputtering a 2 micron thick layer of silicon dioxide onto the structures already existing on the substrate 104.

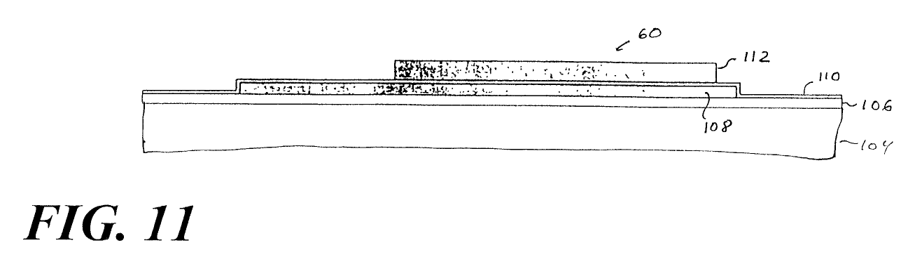

Because photoresist does not adhere well to silicon dioxide, the body layer 112 is first primed by exposure to HMDS (hexamethyldisilazane) at a temperature of 120 C. Those portions of the body layer 112 that will become the mirror 60 and the elbow 70 are then masked and the exposed portions of the body layer 112 are etched away by transene siloxide etchant. This exposes portions of the base electrode-layer 110, as shown in FIG. 11.

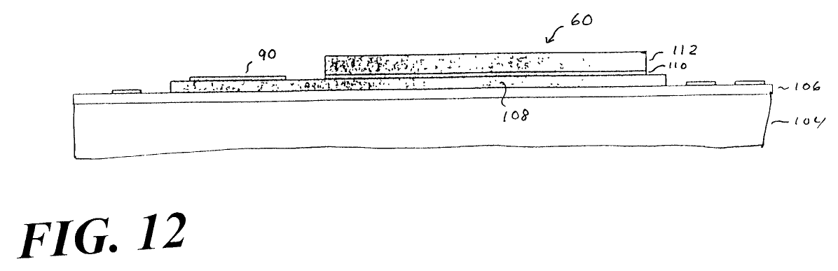

The next step in the fabrication process is to remove those portions of the base electrode-layer 110 that are not needed to form the second and fourth common electrodes 90, 100 of the actuator 58. This is done by placing a layer of photoresist over the various structures already on the substrate 104 and masking those portions that will not be removed. The exposed portions of the base electrode-layer 110 are then ion-milled for approximately 60 seconds with a 200 mA current driven by a 500 volt potential. This removes the top chromium layer. The now exposed gold layer is then wet-etched with a gold etchant, such as transene. This exposes the bottom chromium layer, which is ion-milled in the same way as the top chromium layer. The mask is then removed, leaving behind the leads and the second and fourth common electrodes 90, 100, as shown in FIG. 12.

The next step in the fabrication process is to form the second piezoelectric-layer 88 of the actuator 58. To do so, a very thin (approximately 150 Angstroms) seed layer of silicon dioxide is sputtered onto the structures already laid down on the substrate 104. This seed layer assists in causing the polarization vector of the piezoelectric material to orient itself perpendicularly as it is sputtered onto the substrate 104.

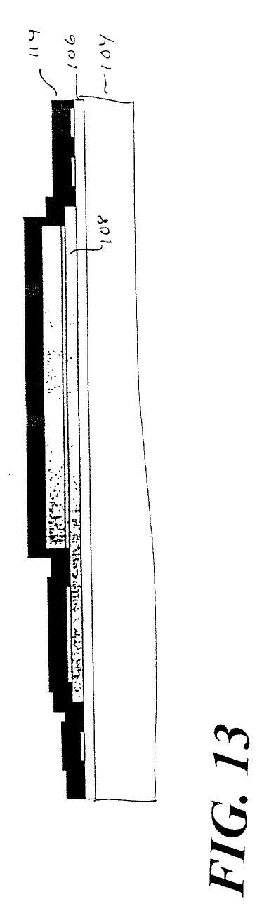

A base piezoelectric-layer 114 is then deposited on the structures already laid down on the substrate 104, as shown in FIG. 13. This is done by sputtering an approximately 2 micron thick layer of zinc oxide on the structures already laid down on the substrate 104.

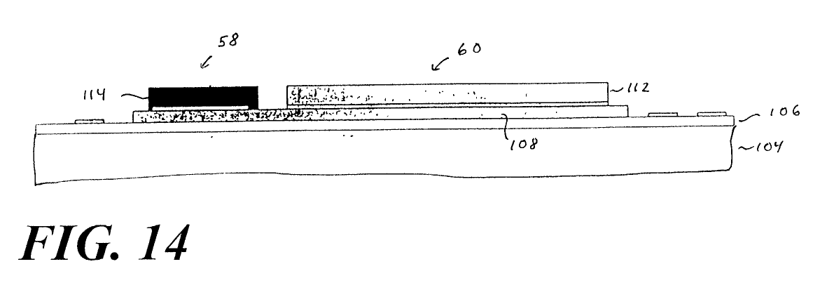

The next step in the fabrication process is to remove those portions of the base piezoelectric-layer 114 that are not needed to form the actuator 58. This is done by masking those portions of the base piezoelectric-layer 114 that are to form the actuator 58, and wet etching the exposed portions of that layer with a solution of 25% HCl in glycerol for four minutes at a temperature of 35 C. This exposes the silicon dioxide seed layer, which is then removed by ion-milling for 60 seconds with a 200 mA current driven by 500 volts. The resulting second layer 88 of the actuator 58, is shown in FIG. 14.

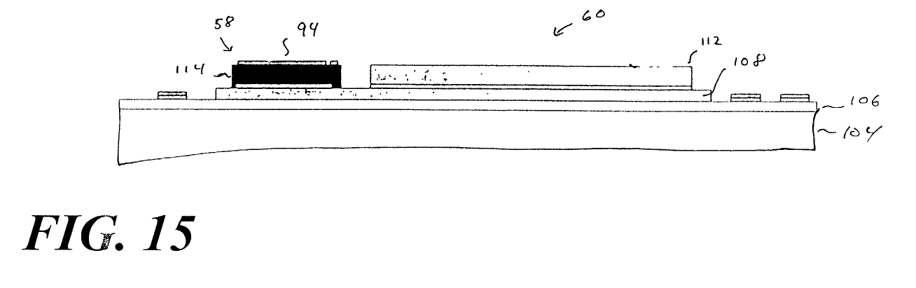

The next step in the fabrication process is to form the pitch electrode 94, the yaw electrode 102, and the leads connecting these electrodes to the controller 38. These structures are all formed by first priming the structures formed thus far with an HMDS primer so that photoresist will better adhere to them. Then the structures laid down thus far are masked by a photoresist layer. Those portions of the photoresist layer that correspond to the pitch electrode 94, the yaw electrode 102, and the leads connecting these electrodes to the controller 38 are then removed. A 200 Angstrom chromium layer, a 2000 Angstrom gold layer, and another 200 Angstrom chromium layer are then sputtered onto the photoresist layer to form a middle electrode-layer 116 on the exposed portions of the base piezoelectric-layer 114. Following removal of the photoresist layer, the electrodes on the base piezoelectric-layer 114 are as shown in FIG. 15.

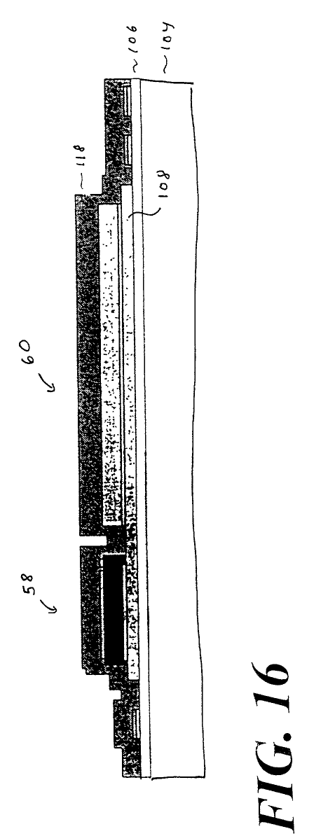

The next step is to form the first piezoelectric-layer 84 of the actuator 58. This is done by depositing an upper piezoelectric-layer 118 in the same manner as described above in connection with the base piezoelectric-layer 114. First, a 150 Angstrom silicon dioxide seed layer is deposited onto the substrate 104 and on all exposed structures on the substrate 104. Then, a 2 micron thick zinc oxide layer is sputtered onto the seed layer. This results in the structure shown in FIG. 16.

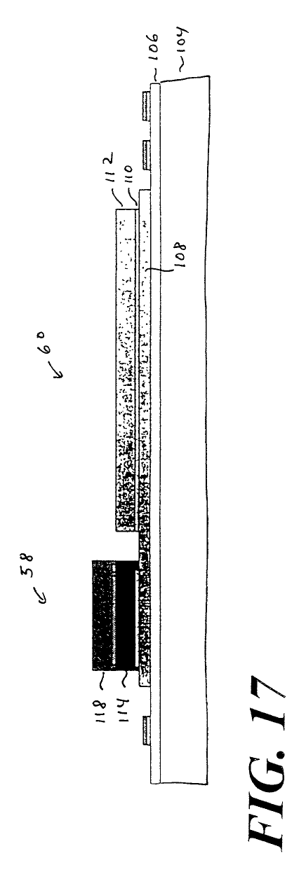

The upper piezoelectric-layer 118 is then masked as described earlier and wet-etched with 25% HCl in glycerol for 4 minutes at a temperature of 35 C. The seed layer is then ion-milled for 60 seconds by a 500 mA current driven by 500 volts. This leaves behind the first piezoelectric-layer 84 of the actuator 58, as shown in FIG. 17.

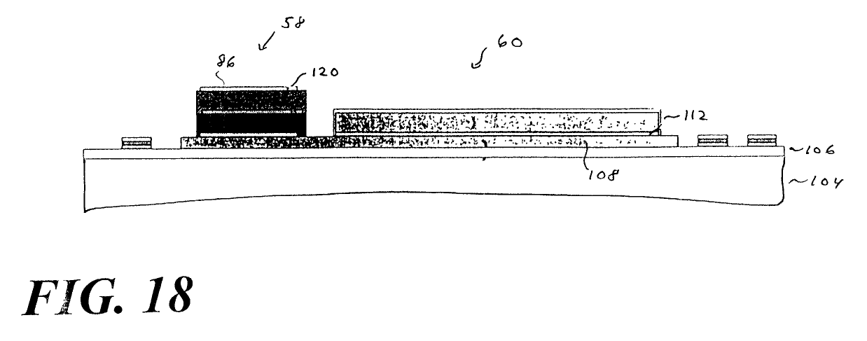

The next step is to form the first and third common electrodes 86, 98 on the actuator 58, to form additional leads to the controller 38, and to add a reflective layer to the portion of the body layer 112 that will become the exposed face of the mirror 60. This is achieved by masking the exposed structure and leaving openings on top of that portion of the body layer 112 that will become the mirror 60, on top of the actuator 58, and on top of the existing leads. A top electrode layer 120 is then formed by sputtering a base chromium layer and a gold layer onto the mask and the openings. This top electrode-layer 120 consists of a 200 Angstrom base chromium layer on top of which is a 2000 Angstrom gold layer. Unlike the base electrode-layer 110, there is no need for a second chromium layer on top of the gold layer in the top electrode-layer 120. Once the sputtering is complete, the mask is removed, leaving behind the first and third common electrodes 86, 98 on the actuator 58, a second set of leads on top of the first set of leads, and a layer of gold that forms the reflective surface of the mirror 60. The resulting structure is shown in FIG. 18.

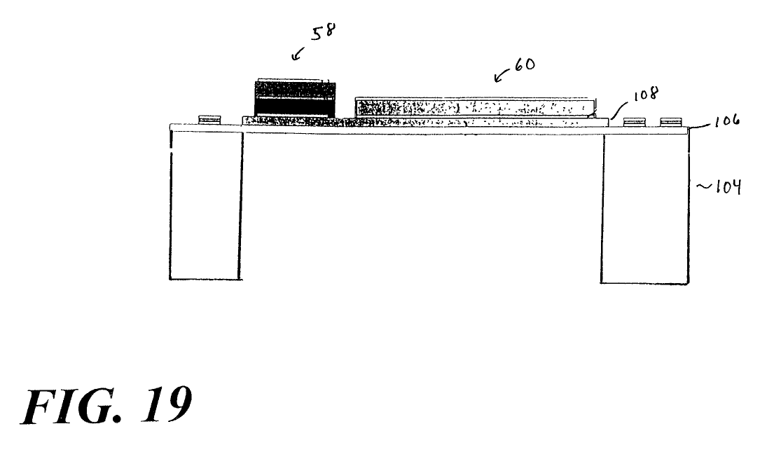

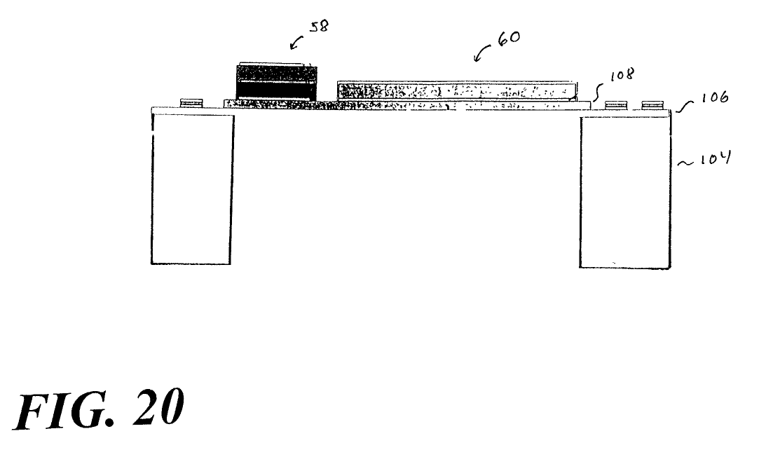

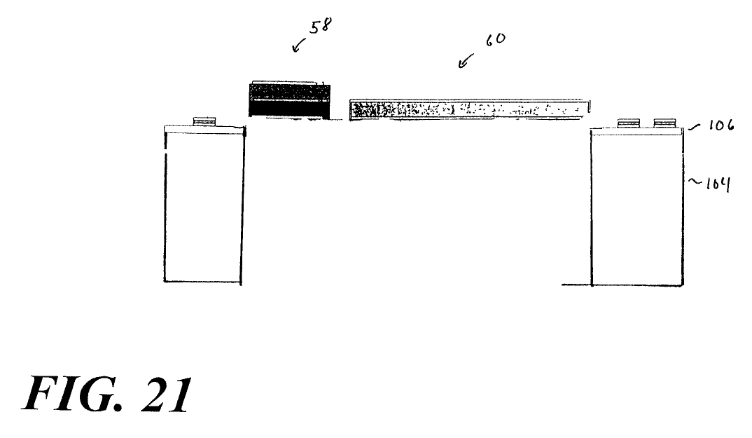

With all the structures now complete, the remaining task is to remove the release layer 108 that temporarily supported the precursors of the mirror 60 and the actuator 58 during the fabrication steps. This is done by performing deep-reactive-ion-etching (DRIE) the back surface of the substrate 104. This etching process proceeds until the stop layer 106 is reached, resulting in the structure shown in FIG. 19. The stop layer is then removed by ion-milling, leaving the release layer 108 exposed, as shown in FIG. 20. Finally, the release layer 108 is removed by exposure to hydrogen peroxide. This leaves behind a cavity into which the mirror 60 and the piezoelectric actuator 58 are free to move, as shown in FIG. 21.

Referring again to FIG. 7, when a voltage difference is imposed between the pitch-electrode 94 and the common electrodes 86, 90, the layers 84, 88 deform in directions that depend on the polarity of the voltage difference. The extent of the deformation depends on the magnitude of the voltage difference.

By controlling the voltage differences between the pitch electrode 94 and the common electrodes 86, 90, the controller 38 can cause the first arm 72 to deflect upward or downward by a selected amount. This causes the first arm 72, and hence the mirror 60 attached to the second arm 74, to pitch up and down. In this way, voltages applied to the pitch electrode control the pitch angle of the mirror 60.

Similarly, by controlling the voltage differences between the yaw electrode 102 and the common electrodes 98, 100, the controller 38 causes the second arm 74 to deflect upwards or downwards. Because the second arm 74 is perpendicular to the first arm 72, this deflection of the second arm 74 causes the mirror 60 to yaw left and right. In this way, voltages applied to the yaw-electrode 102 control the yaw angle of the mirror 60.

One advantage of the piezoelectric actuator 58 is apparent in cases in which the mirror 60, for some reason, comes into contact with a substrate over which it is mounted. Because the mirror 60 is so small, it is susceptible to the force of stiction. To overcome this stiction force, and to thereby free the mirror 60, it is necessary to apply a force in the direction opposite that in which the stiction force acts. In an electrostatically actuated mirror, on the other hand, the electrostatic actuator can only apply an attractive force between the mirror and the substrate. It cannot apply the repulsive force necessary to overcome stiction between the substrate and the mirror. In contrast, a piezoelectric actuator 58 according to the invention can apply force in either direction and can therefore overcome the force of stiction.

Another advantage of the piezoelectric actuator 58 is that the electrostatic field used to deform the piezoelectric material is of low magnitude and mostly confined to the piezoelectric material. As a result, fringing fields are very small. This enables a large number of actuators (and hence mirrors) to be packed into a very small area without the electrostatic field generated by one actuator interfering with the operation of a nearby actuator.

The magnitude of the required voltage between the common electrodes and either of the pitch or yaw-electrodes is on the order of 100 volts when actuation is required. This results in a brief flow of current that charges the capacitor formed by the pair of electrodes. Once the capacitor is charged, a small current is required to replace charge lost by conduction through the piezoelectric material. The amount of this current depends on the resistivity of the piezoelectric material.

In one embodiment, the resistivity is approximately 400 MΩcm. This results in the consumption of 50 microwatts per mirror element at maximum voltage. For a device with two arrays, each having 1000 mirror elements, the maximum power consumption is 0.1 watt.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What we claim as new and secured by Letters Patent is:

1. An actuator for controlling a pitch angle and a yaw angle of a mirror in a fiber-optic switch, said actuator comprising:
a piezoelectric strip having
a first arm extending from a substrate in a first direction and
a second arm for attachment to said mirror, said second arm extending from said first arm in a second direction different from said first direction
a pitch-electrode in electrical communication with said first arm for deflecting said first arm; and
a yaw-electrode in electrical communication with said second arm for deflecting said second arm.

2. The actuator of claim 1 further comprising a controller in communication with said pitch-electrode and said yaw-electrode, said controller adapted to apply a pitch voltage to said pitch-electrode and a yaw voltage to said yaw-electrode.

3. The actuator of claim 1 wherein said second arm extends in a direction perpendicular to said first direction.

4. The actuator of claim 1 further comprising a stiffening element at a point at which said second arm extends from said first arm.

5. The actuator of claim 1 wherein said first arm has a distal end and said second arm extends from said distal end of said first arm.

6. The actuator of claim 1, wherein said piezoelectric strip comprises a first layer and a second layer, said first and second layer meeting at an interface.

7. The actuator of claim 1 further comprising a first common electrode disposed on a first surface of said piezoelectric strip.

8. The actuator of claim 7 further comprising a second common electrode disposed on a second surface of said piezoelectric strip.

9. The actuator of claim 6 further comprising a first common electrode in electrical communication with said first layer and a second common electrode in electrical communication with said second layer.

10. The actuator of claim 9 wherein said first common-electrode is disposed on said first layer opposite said pitch electrode and said actuator further comprises a second common-electrode disposed on said second layer opposite said pitch electrode.

11. The actuator of claim 1 wherein said piezoelectric strip comprises a piezoelectric material that can be deposited on the substrate by thin-film deposition.

12. The actuator of claim 11 wherein said piezoelectric strip comprises zinc oxide.

13. The actuator of claim 1 wherein said second arm has a distal end for attachment to said mirror.

14. A method for controlling pitch and yaw angle of a mirror in a fiber-optic switch, said method comprising:
applying a selected first signal to a pitch-electrode in electrical communication with a first arm of a piezoelectric bimorph strip, said first arm defining a first direction;
applying a selected second signal to a yaw-electrode in electrical communication with a second arm of said piezoelectric bimorph strip, said second arm extending in a direction different from said first direction and having a mirror attached to a distal end thereof.

15. The method of claim 14 further comprising determining said first signal and said second signal on the basis of a desired pitch angle and a desired yaw angle.

16. A mirror element for a fiber-optic switch, said mirror element comprising:
a piezoelectric actuator deflectable with two degrees of freedom;
a mirror attached to said piezoelectric actuator;
an electrical connection to said piezoelectric actuator for providing a control voltage to selectively deflect said piezoelectric actuator to control a pitch angle of said mirror and a yaw angle of said mirror.

17. The mirror element of claim 16 wherein said piezoelectric actuator comprises a piezoelectric strip having a proximal end and a distal end, said piezoelectric strip having:
a first arm extending from said proximal end of said piezoelectric strip, said first arm defining a first direction; and
a second arm for attachment to said mirror, said second arm extending between said first arm and said distal end of said piezoelectric strip, said second arm defining a second direction different from said first direction.

18. The mirror element of claim 16 wherein said first direction is perpendicular to said second direction.

19. The mirror element of claim 16 wherein said first arm extends from said proximal end of said piezoelectric strip to an elbow and said second end extends from said elbow to said distal end of said piezoelectric strip.

20. The mirror element of claim 19 wherein said elbow further comprises a stiffening element.

21. The mirror element of claim 17 wherein said mirror is attached to said distal end of said piezoelectric strip.

22. The mirror element of claim 16 wherein said electrical connection comprises:
a pitch-electrode in electrical communication with said piezoelectric actuator for deflecting said actuator to control a pitch angle of said mirror; and
a yaw-electrode in electrical communication with said actuator for deflecting said actuator to control a yaw angle of said mirror.

23. The mirror element of claim 17 further comprising a controller in communication with said electrical connection for providing said control voltage.

24. The mirror element of claim 16 wherein said piezoelectric actuator comprises:
a first deflecting element that deflects along a first direction to control primarily said pitch angle; and
a second deflecting element that deflects along a second direction to control primarily said yaw angle, said second direction being different from said first direction.

25. The mirror element of claim 24 wherein said mirror is attached to one of said first and second deflecting elements.

26. The mirror element of claim 16 wherein said piezoelectric actuator comprises a bimorph having a first layer and a second layer meeting at an interface.

27. The mirror element of claim 16 wherein said piezoelectric actuator comprises a piezoelectric material that can be deposited on a substrate by thin-film deposition.

28. The mirror element of claim 16 wherein said piezoelectric material comprises zinc oxide.

29. A fiber-optic switch for directing a beam emerging from an input optical fiber to a selected output optical fiber, said fiber-optic switch comprising:
a first array of mirror elements, each of said mirror elements including
a steerable mirror having a variable pitch angle and a variable yaw angle,
a piezoelectric strip having a first arm extending in a first direction and a second arm extending in a second direction different from said first direction, said second arm being coupled to said steerable mirror;
a pitch-electrode in electrical communication with said first arm for deflecting said first arm; and
a yaw-electrode in electrical communication with said second arm for deflecting said second arm.

30. The fiber-optic switch of claim 29 further comprising a second array of mirror elements, each of said mirror elements including:
a moveable mirror having a variable pitch angle and a variable yaw angle,
a piezoelectric strip having a first arm extending in a first direction and a second arm extending in a second direction different from said first direction, said second arm being coupled to said steerable mirror;
a pitch-electrode in electrical communication with said first arm for deflecting said first arm; and
a yaw-electrode in electrical communication with said second arm for deflecting said second arm.

31. The fiber-optic switch of claim 29 further comprising a controller in communication with said pitch-electrode and said yaw-electrode, said controller adapted to apply a pitch voltage to said pitch-electrode and a yaw voltage to said yaw-electrode.

32. The fiber-optic switch of claim 31 further comprising a position sensor in communication with said controller, said position sensor providing an error signal indicative of an error in said pitch angle and said yaw angle.

33. The fiber-optic switch of claim 32 wherein said position sensor comprises a plurality of photosensors arranged in an annulus having a central axis orthogonal to a plane defined by said annulus, said annulus being disposed so that in the absence of error in said pitch angle and said yaw angle, a central axis of said beam is coincident with said central axis of said annulus.

34. The fiber-optic switch of claim 33 wherein said plurality of photosensors comprises four photosensors.

35. The fiber-optic switch of claim 32 wherein said controller adjusts said pitch voltage and said yaw voltage in response to said error signal.

36. A control system for controlling an orientation of a mirror in a fiber-optic switch, said control system comprising:
a position sensor disposed to intercept a beam reflected from said mirror, said position sensor providing an error signal indicative of a deviation of said orientation from a desired orientation;
a controller in communication with said position sensor for receiving said error signal and generating, in response to said error signals, control signals for correcting said orientation of said mirror; and
a mirror-actuator coupled to said mirror and in communication with said controller, said mirror-actuator changing said orientation of said mirror in response to said control signals.

37. The control system of claim 36 wherein said position sensor comprises a plurality of photosensors arranged in an annulus having a central axis orthogonal to a plane defined by said annulus, said annulus being disposed so that in the absence of error in said orientation, a central axis of said beam is coincident with said central axis of said annulus.

38. The control system of claim 37 wherein said plurality of photosensors comprises four photo sensors.

39. The control system of claim 38 wherein each of said photosensors subtends an angle of less than ten degrees of arc.

40. The control system of claim 37 wherein said plurality of photosensors are disposed on a lens.

41. A fiber-optic mirror array comprising:
a substrate;
a plurality of piezoelectric actuators supported by said substrate; and
a plurality of mirrors each coupled to a corresponding piezoelectric actuator from said plurality of piezoelectric actuators to provide relative motion between each mirror and said substrate in response to a piezoelectric drive signal to said corresponding piezoelectric actuator.

42. The mirror array of claim 41, wherein each mirror is less than six-hundred microns in diameter.

43. The mirror array of claim 41, wherein a first center of a first mirror from said plurality of mirrors and a second center of a second mirror selected from said plurality of mirrors are separated from each other by less than two millimeters.

44. The mirror array of claim 41, wherein the plurality of mirrors comprises at least five-hundred mirrors.

45. The mirror array of claim 41, wherein
each mirror is less than six-hundred microns in diameter;
a first center of a first mirror from said plurality of mirrors and a second center of a second mirror selected from said plurality of mirrors are separated from each other by less than two millimeters;
and wherein the plurality of mirrors comprises at least five-hundred mirrors.

46. The mirror array of claim 41, wherein each piezoelectric actuator comprises a first layer of a piezoelectric material, a second layer of said piezoelectric material, and a first electrode disposed between said first layer and said second layer.

47. The mirror array of claim 46, wherein each piezoelectric actuator further comprises a second electrode disposed on a top surface of said first layer and a third electrode disposed on a bottom surface of said second layer.

48. The mirror array of claim 41, wherein each piezoelectric actuator comprises a first arm extending in a first direction and a second arm extending in a second direction different from said first direction, and wherein said second arm couples to a corresponding mirror from said plurality of mirrors.

49. A fiber-optic switch comprising:
an input face positioned to receive a plurality of input optical fibers;
a first mirror array positioned to selectively redirect a light beam emerging from an input optical fiber from said plurality of input optical fibers;
a second mirror array positioned to selectively redirect said light beam redirected by said first mirror array; and
an output face positioned to couple, to an output optical fiber from a plurality of output optical fibers, said light beam redirected by said second mirror array,
wherein said first and second mirror arrays each comprise
a plurality of piezoelectric actuators, and
a plurality of mirrors each coupled to a corresponding piezoelectric actuator from said plurality of piezoelectric actuators.

50. A method for fabricating a fiber-optic mirror array including a substrate, a plurality of piezoelectric actuators supported by the substrate, and a plurality of mirrors each coupled to a different one of the plurality of piezoelectric actuators to provide relative motion between each mirror and the substrate in response to a piezoelectric drive signal to the corresponding piezoelectric actuator, the method comprising:
forming a patterned release layer over the substrate to define a plurality of target areas;
forming a patterned mirror layer over the release layer;
forming at least one patterned layer of piezoelectric material over the substrate to separately cover at least a portion of the release layer at each target area; and
removing the release layer to cause the patterned mirror layer to define the plurality of mirrors and cause the at least one patterned layer of piezoelectric material to define the plurality of piezoelectric actuators.

51. The method of claim 50, wherein the formation of at least one patterned layer of piezoelectric material comprises forming two patterned layers of piezoelectric material and an electrode layer between the two patterned layers of piezoelectric material to define a piezoelectric bimorph layer.

52. The method of claim 50, wherein the removal of the release layer comprises ion etching the underside of the substrate to expose the release layer and wet etching the exposed release layer.

53. The method of claim 50, further comprising forming at least one patterned electrode layer over the substrate to separately cover at least a portion of the release layer at each target area.

54. The method of claim 53, wherein at least one of the electrode layers comprises two chromium layers sandwiching a gold layer.
